(19) United States
(12) Patent Application Publication
(10) Pub. No.: US 2022/0305844 A1
(43) Pub. Date: Sep. 29, 2022

(54) Wheel and mudcover

(71) Applicant: Wheel Pros, LLC, Greenwood Village, CO (US)

(72) Inventor: Daniel I. Ricehouse, Phoenix, AZ (US)

(73) Assignee: Wheel Pros, LLC, Greenwood Village, CO (US)

(21) Appl. No.: 17/701,550

(22) Filed: Mar. 22, 2022

Related U.S. Application Data
(60) Provisional application No. 63/164,767, filed on Mar. 23, 2021.

(51) Int. Cl. B60B 7/00

(52) U.S. Cl. CPC B60B 7/0013; B60B 31/06

(57) ABSTRACT

A wheel with a tire bead area, in which a tire bead sits, and an aero lip which provides structural integrity to the wheel and anchors the part of the wheel that secures and protects a mudcover. Inside of the aero lip is a cover insert that protects the mudcover. The mudcover rests against a cover support ledge, and is bolted with a mudcover bolt into a threaded insert that is held by a cover tab . The mudcover is bolted directly to the wheel, as opposed to the prior art. The mudcover bolt can also be a twist-rivet or nut-rivet combination.

### CROSS REFERENCE TO RELATED APPLICATIONS

This utility patent application claims priority back to U.S. Provisional Application No. 63/164,767, filed Mar. 23, 2021, the contents of which are incorporated herein in their entity by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of automobile wheels and related devices, and more specifically, to a wheel with a unique design that allows for a modular mudcover to be selectively attached and replaced as needed.

While many casual racing fans know mostly about Formula 1 and NASCAR, there exists a wide variety of other racing sports that are held on dirt tracks. Racing types such as funny cars, sprint cars are generally run over tracks covered with loose dirt, hence emphasizing the driving abilities of drivers adept at drifting and other racing maneuvers that allow them to stay on a relatively straight course as they navigate the racetrack.

While slamming into a tight turn with the back wheels drifting and the car fishtailing back and forth looks spectacular on camera, one problem that all such drivers face is the accumulation of dirt and mud in the wells of their wheels. This accumulation slows them down, and if unequally plastered on the side of the wheel, can throw off the wheel's balance, leading to, at best worse performance, and, at worst, catastrophic failure of the wheel.

Racers aren't the only ones to face this problem through. Many ATV drivers, while not tearing around the turns as fast as the average Sprint racer, still have problems with dirt, sand and mud accumulating inside the well of their wheels. This is particularly prevalent when the ATV driver is driving upon a wet or muddy surface, and since this is half the fun of driving ATV's, it happens quite frequently.

Thus, there has been a need in both the racing and ATV industries to come up with a method of keeping the mud and dirt out of the wheel wells.

There are several products commercially available today that had “mudcovers”, which are basically round discs, that bolt onto a wheel. While these products may keep the mud out, they have some drawbacks. First, the connection between the wheel and mudcover is exposed to the elements and, hence, subject to easy breakage as dirt clods and rocks fly up and hit the bolts. Second, the mudcover is not modular, such that if there is a small ding on one edge of the mudcover, the entire mudcover must be replaced. Third, these prior arts require a bracket to connect the mudcover to the wheel, as opposed to the current invention which allows a mudcover to bolt directly to the wheel.

The current invention solves this problem by providing a wheel with a special aero lip and recessed cover support ledge, and a mudcover that bolts into a cover support ledge, with a mudcover bolt going through a hole in the mudcover and attaching to a cover tab that hangs behind the aero lip, such that the mud cover bolt is shielded from the brunt of the damage from loose dirt and rocks. The mudcover is, optionally, modular such that if one section is damaged, only that section needs to be replaced.

### Objects of the Invention

It is therefore an object of the present invention to provide a wheel upon which a mudcover can be attached safely and in a manner that protects the mudcover from the usual wear and tear a mudcover faces.

An additional object of the invention includes providing a wheel with a recessed area that receives the mudcover, and a cover tab with a threaded insert into which a mudcover bolt mates to secure the mudcover to the wheel.

Another object of the invention is to provide a wheel/mudcover assembly where the mudcover mounts directly to the wheel as opposed to the prior art which requires a bracket.

A final object of the invention is to provide a modular mudcover which can be sectionally replaced if a section is damaged.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a perspective view of a modular mudcover being attached to a wheel.

FIG. 2 is a cross-sectional side view of the wheel, showing the location of the invention.

FIG. 3 is a perspective view of a mudcover about to the attached to a uniquely designed wheel.

FIG. 4 is a perspective view of the mudcover and wheel in FIG. 3, where the mudcover has been attached to the wheel.

FIG. 5 is a partial cutaway view showing a modular mudcover attached to the wheel with one quadrant of the mudcover not yet attached.

FIG. 6 is a side, cutaway, close-up view of the mudcover bolt being threaded through the threaded insert to attach a mudcover quadrant.

FIG. 7 is a side, partial cut-away drawing of the wheel without a mudcover attached.

FIG. 8 is a perspective view of a different version of the plug that is secured in the wheel, showing a serrated sided plug.

FIG. 9 is a perspective view of a different version of the plug that is secured in the wheel, showing a hexagonally sided plug.

FIG. 10 is a perspective view of a different version of the plug that is secured in the wheel, showing a spring-loaded plug.

FIG. 11 is a perspective view of the hexagonally-sided plug ready for insertion into a hexagonally side punch out in the wheel, such that the plug will not spin in the wheel.

FIG. 12 is a perspective view of the hexagonally-sided plug From FIG. 11 after it has been inserted into a hexagonally side punch out in the wheel, such that the plug will not spin in the wheel.

FIG. 14 is a perspective view of the spring-loaded plug ready for insertion into in the wheel, such that the plug will not spin in the wheel.

FIG. 15 is a perspective view of the spring-loaded plug ready for insertion into in the wheel, such that the plug will not spin in the wheel.

FIG. 16 is a perspective view of the spring-loaded plug after it has been inserted into the wheel and the mandrels of the rivets have been removed.

FIG. 17 is a perspective view of another version of the invention where a nut is ready to be attached to the back of the cover support ledge.

FIG. 18 is a perspective view of the embodiment of the invention described in FIG. 17 after the nut has been attached.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

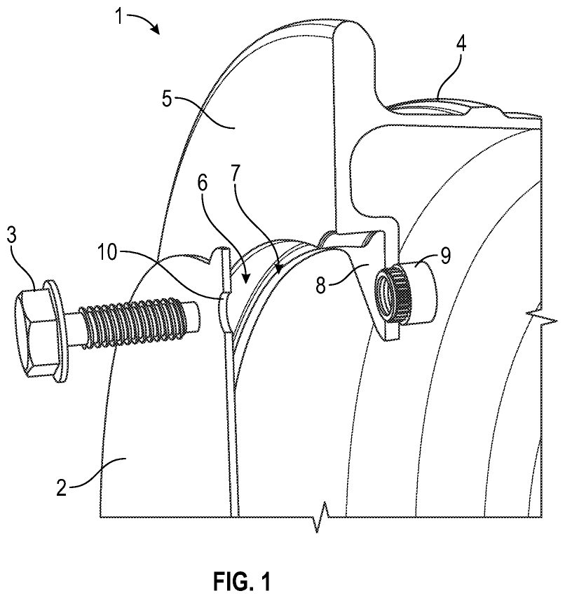

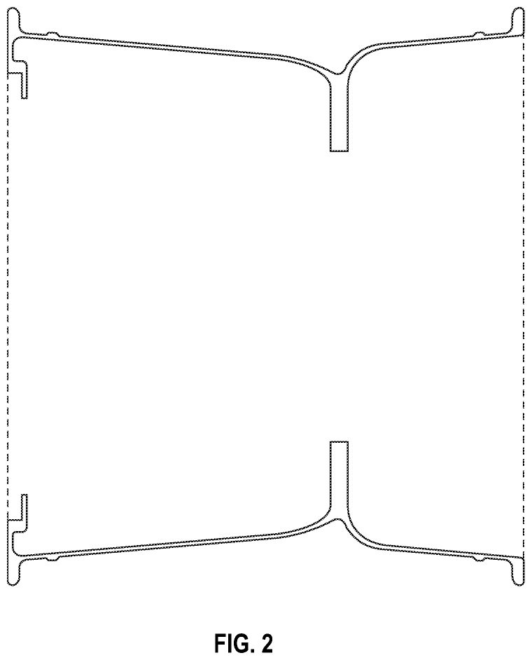

FIG. 1 is a perspective view of a modular mudcover 2 being attached to a wheel 1. Wheel 1 has a tire bead area 4, in which the tire bead sits, and an aero lip 5 which provides structural integrity to the wheel and anchors the part of the wheel that secure and protect the mudcover 2. Inside of the aero lip 5 is a cover insert 6 that serves to protect the mudcover. The mudcover rests against a cover support ledge 7 and is bolted with a mudcover bolt 3 into a threaded insert 9 that is held by a cover tab 8. The mudcover in this figure is modular, with a mudcover hole showing where 4 mudcover sections can be bolted to a wheel such that if one section is damaged, only that section needs to be replaced, as opposed to the prior art which would require that the entire mudcover be removed.

FIG. 2 is a cross-sectional side view of the wheel, showing the location of the invention.

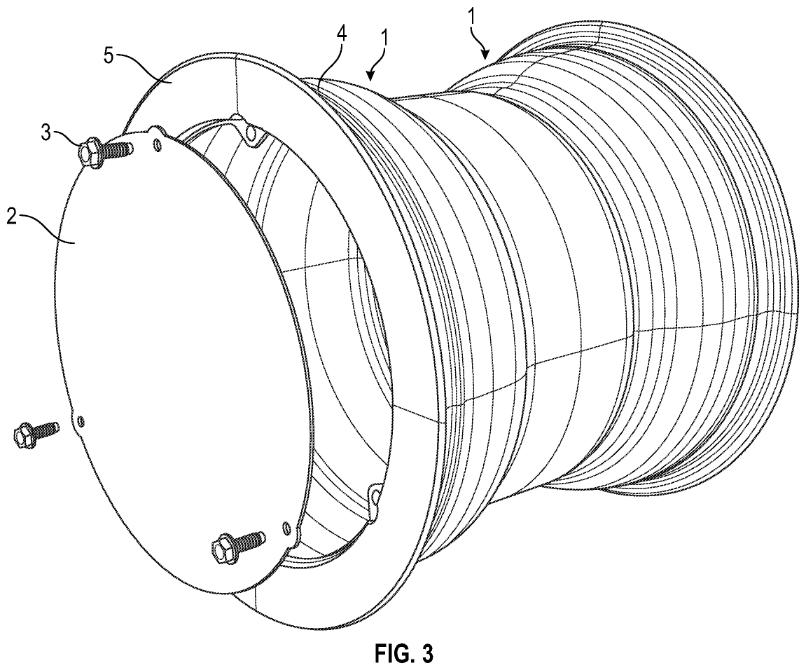

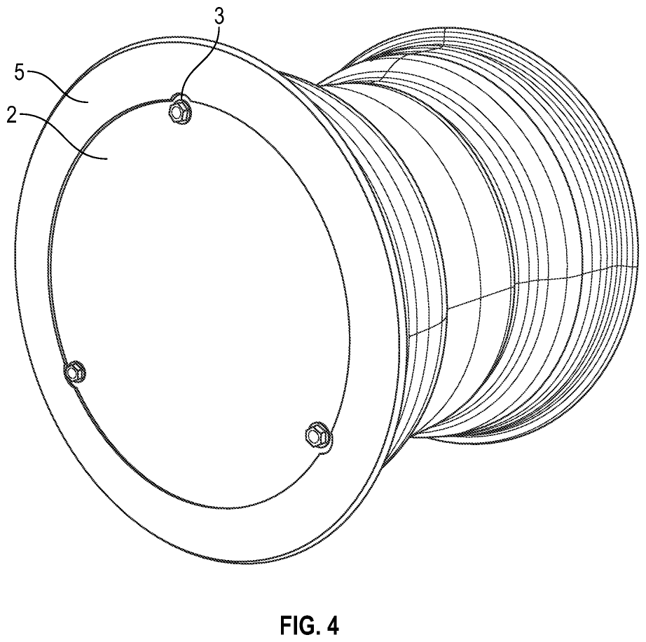

FIG. 3 is a perspective view of a mudcover about to the attached to a uniquely designed wheel. The aero lip 5 provides a cavity (the cover insert, 6 in FIG. 1) into which the mudcover 2 slips. Because it is inserted into the protective cavity, the mudcover is protected from rocks and dirt that are common a certain car races in out outdoor ATV, UTV and other types of driving. The mudcover bolt 3 is inserted through a hole in the mudcover and threaded into a threaded insert (9 in FIG. 1) which removably secures the mudcover to the wheel. Notice that the mudcover in this embodiment has four quadrants. The mudcover can be an entirely intact mudcover, or a modular mudcover, which would allow a user to replace only a 90-degree section of the mudcover should only a portion be damaged.

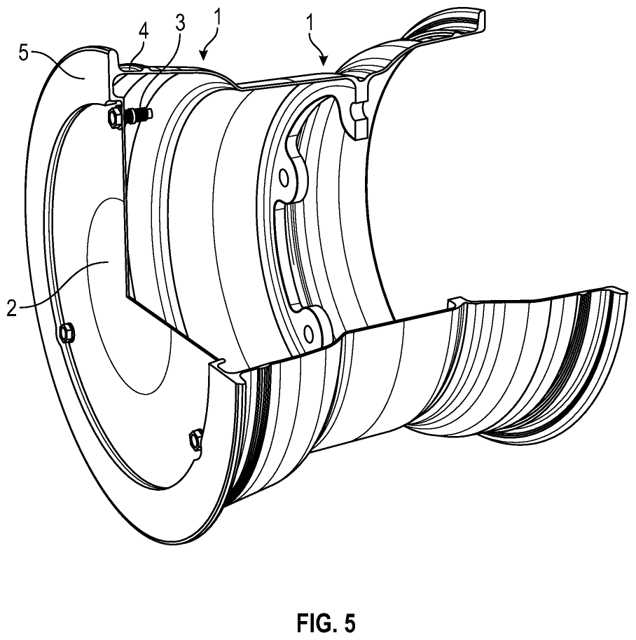

FIG. 4 is a perspective view of the mudcover and wheel in FIG. 3, where the mudcover has been attached to the wheel. The mudcover bolts 3 have been tightened, and the mudcover 2 is secured to the wheel 5. The mudcover is inset against the rest of the aero lip 5 which offers is some protection.

FIG. 5 is a partial cutaway view showing a modular mudcover attached to the wheel with one quadrant of the mudcover not yet attached. This drawing illustrates how the cavity provided by the cover insert 6 put the mudcover 2 and the mudcover bolts 3 in a place where they are protected by the aero lip 5 from rocks and other debris thrown up into them during hard racing for ATV/UTV use. This figure also illustrates how three mudcover bolts 3 and retain four separate quadrants of mudcover modules.

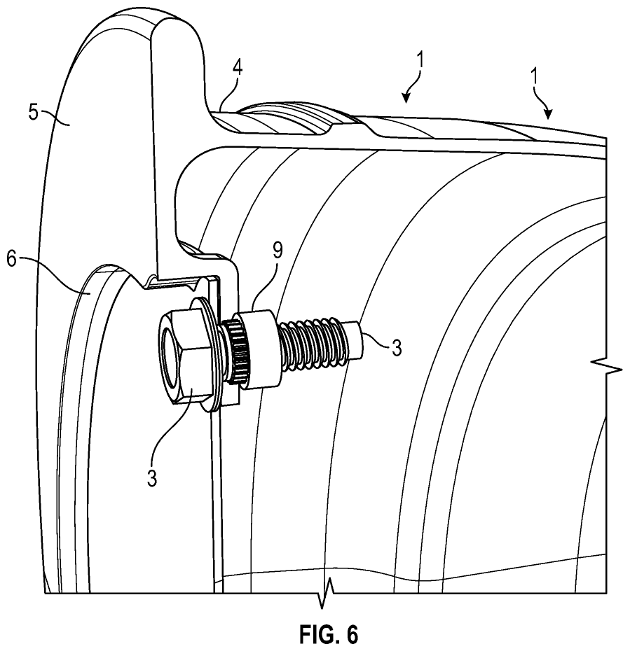

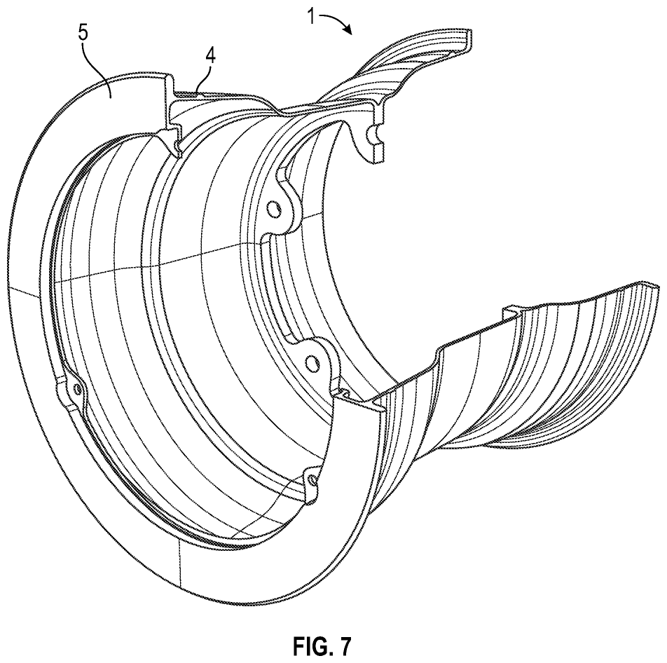

FIG. 6 is a side, cutaway, close-up view of the mudcover bolt being threaded through the threaded insert to attach a mudcover quadrant. Mudcover bolt 3 has been threaded into the threaded insert 9, securing the mudcover quadrant through its mudcover partial hole (10 in FIG. 1). Cover insert 6 allows for the mudcover 2 to be inserted into a protective cavity to minimize damage to the mudcover.

FIG. 7 is a side, partial cut-away drawing of the wheel without a mudcover attached. This figure shows how the aero lip 5 extends all the way around the wheel, providing the cover insert in which the mudcover fits.

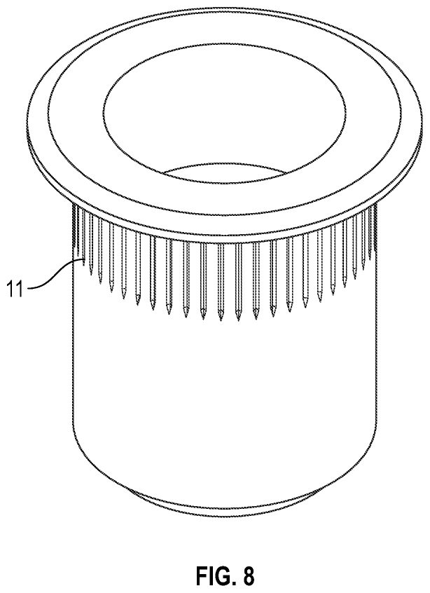

FIG. 8 is a perspective view of a different version of the plug that is secured in the wheel, showing a serrated sided plug 11. With this version, a series of serrations along the side of the plug grip its corresponding circular punch out on the wheel to prevent the plug from rotating inside the wheel.

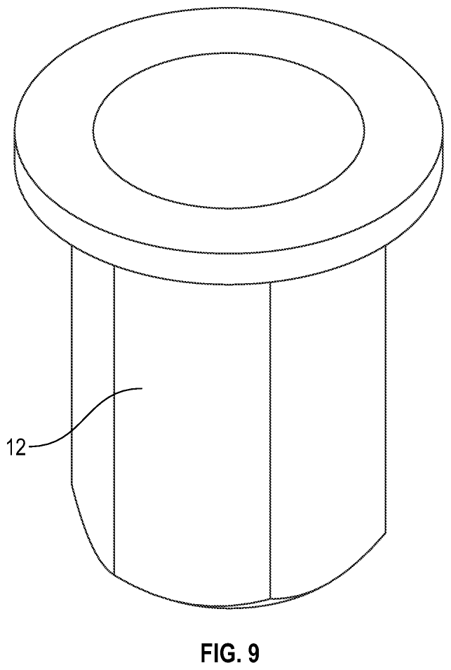

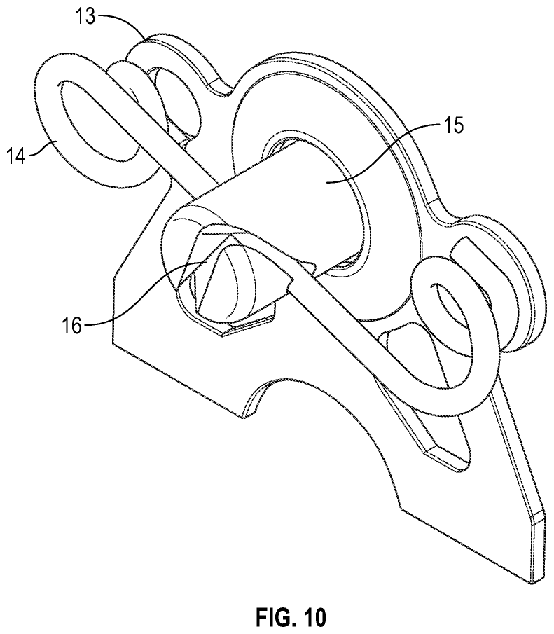

FIG. 9 is a perspective view of a different version of the plug that is secured in the wheel, showing a hexagonally sided plug 12. The hexagonally-sided plug fits into a hexagonally-side punch out in the wheel such that the plug does not spin within its punch out.

FIG. 10 is a perspective view of a different version of the plug that is secured in the wheel, showing a spring-loaded plug. In this version, generally referenced as 13, a spring 17 is wound into two coils which are attached to the wheel by pop rivets (not shown in this figure). In the center of the spring 14 is a straight section that fits into a slot 16 in the screw 15. The screw 15 is rotated to pull the spring upward and to place a load on it.

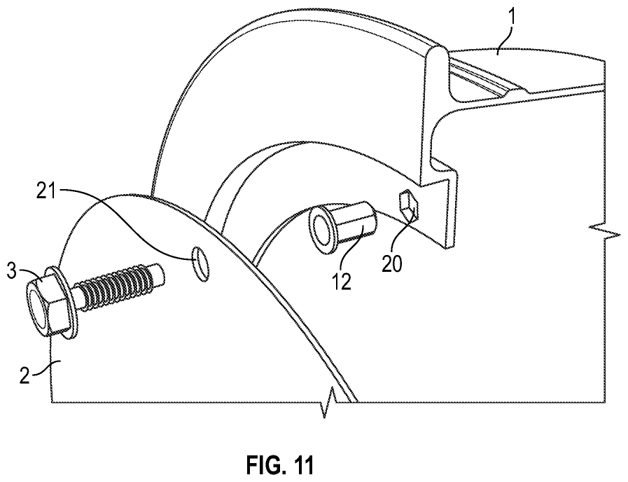

FIG. 11 is a perspective view of the hexagonally-sided plug 12 ready for insertion into a hexagonally side punch out 20 in the wheel 1, such that the plug will not spin in the wheel. A mudcover bolt 3 is inserted through a mudcover bolt hole 21 in the mudcover 2. Threads from the mudcover bolt 3 mate with corresponding threads on the inner surface of the hexagonally-sided plug 12, allowing the mudcover 2 to be removable secured to the wheel 1.

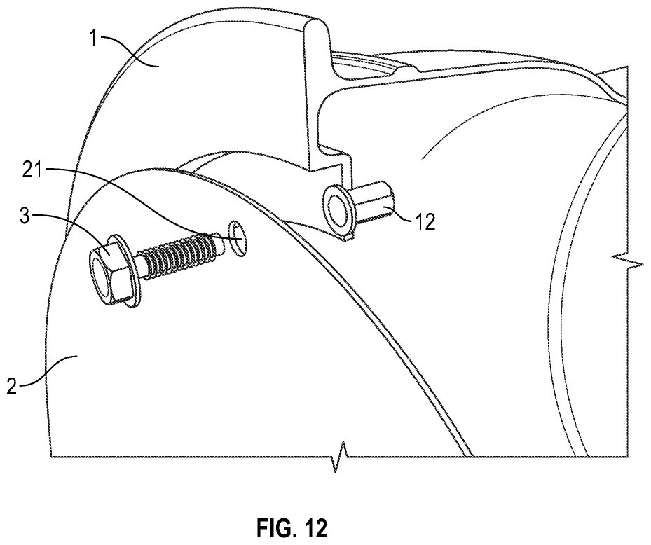

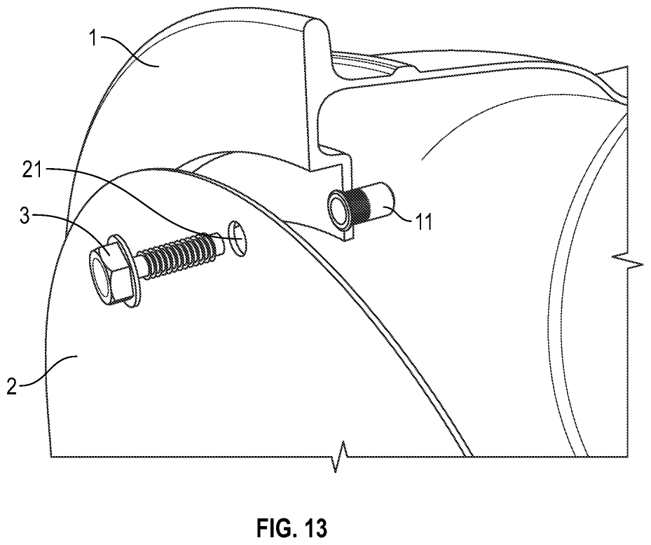

FIG. 12 is a perspective view of the hexagonally-sided plug 12 From FIG. 11 after it has been inserted into a hexagonally side punch out in the wheel, such that the plug will not spin in the wheel. The mudcover bolt 3 is inserted through the mudcover bolt hole 21 and will screw the mudcover 2 up against the wheel 1, because the hexagonally-sided plug 12 will not spin.

FIG. 13 is a perspective view of a serrated-sided plug 11 that has been forced into a round hole in the wheel 1. The serrations on the side of the plug prevent it from spinning, while a mudcover bolt 3 is used to bolt the mudcover 2 to the wheel 1.

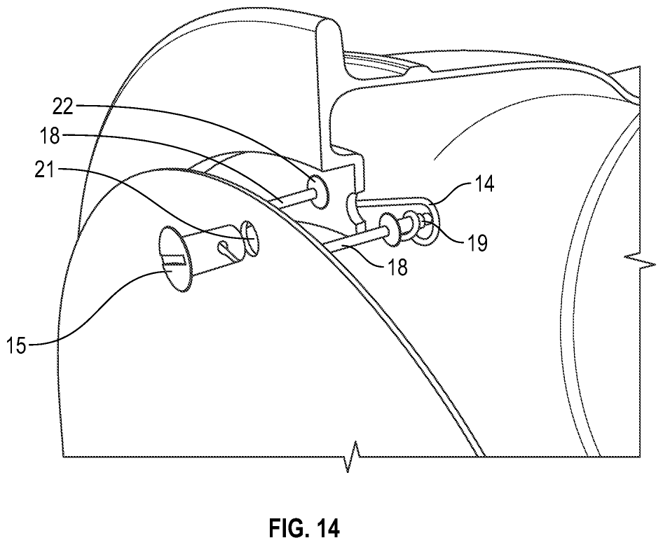

FIG. 14 is a perspective view of the spring-loaded plug ready for insertion into in the wheel, such that the plug will not spin in the wheel. A spring 14 has been wound into two coils, which are attached to the wheel by rivets. Each rivet has a mandrel 18, which is used to force the rivet pin 19 against the back of the wheel, pinning the spring coil against the rivet pin 19. The mandrels 18 will be snapped off to allow the mudcover to nestle in the cover insert of the wheel. A screw 15 will be inserted through the mudcover bolt hole 21, and will engage a straight portion of the spring. As the screw is turned, it will pull the spring 14 against the back of the wheel, securing the mudcover in place.

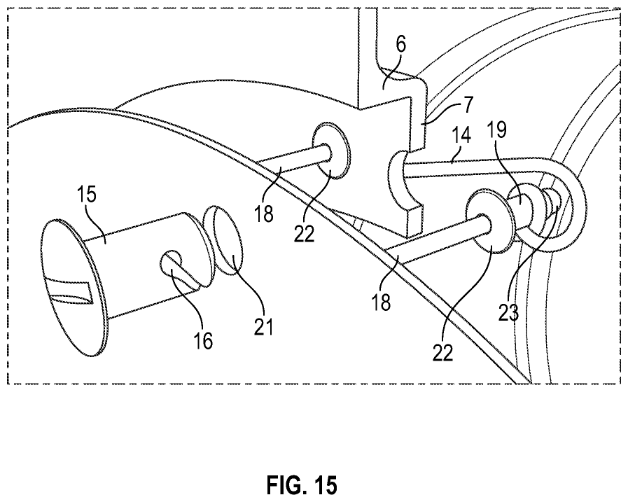

FIG. 15 is a perspective view of the spring-loaded plug ready for insertion into in the wheel, such that the plug will not spin in the wheel. A spring 14 has been wound into two coils, which are attached to the wheel by rivets. Each rivet has a mandrel 18, which is used to force a mandrel head 23 against the rivet pin 19, causing it to expand, pulling against the rivet pin 19, against the cover support ledge 7 of the wheel. The mandrels 18 will be snapped off to allow the mudcover to nestle in the cover insert 6 of the wheel. A screw 15 will be inserted through the mudcover bolt hole 21 and will engage a straight portion of the spring. As the screw is turned, it will pull the spring 14 against the back of the wheel, securing the mudcover in place.

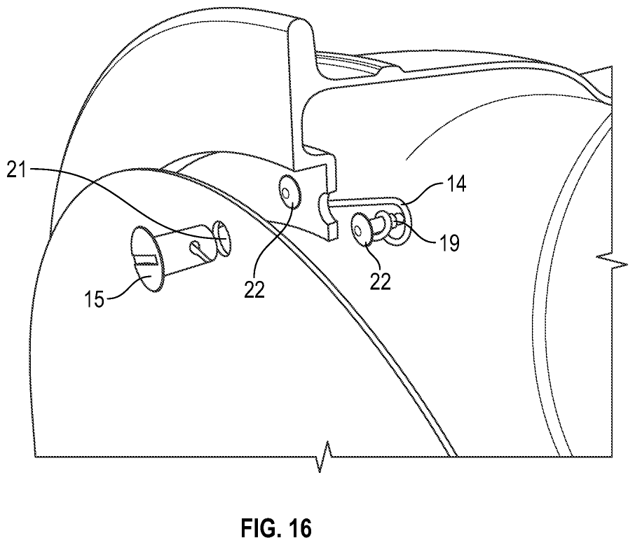

FIG. 16 is a perspective view of the spring-loaded plug after it has been inserted into the wheel and the mandrels of the rivets have been removed. In this figure, the spring 15 has been forced against the back of the cover support ledge by the crushed rivet pin. The rivet heads 22 and now relatively flush with the face of the cover support ledge 7, since the mandrels (18 in other figures) have been removed. The mudcover can now be pulled into the cover insert where it will be protected by flying dirt and rocks during racing of the sprint car.

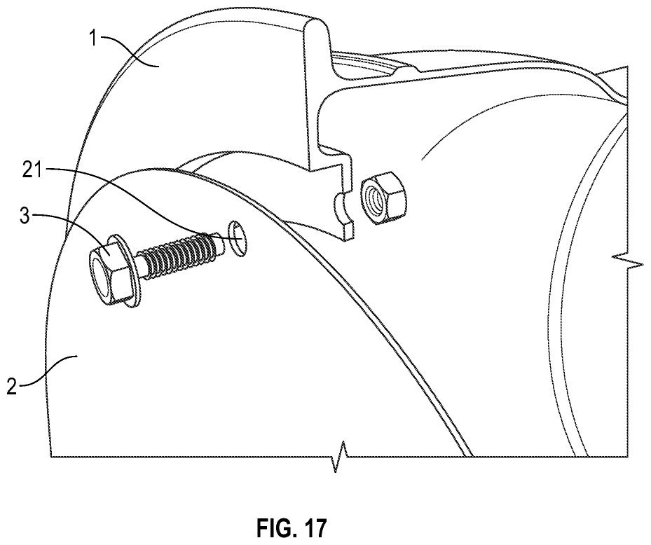

FIG. 17 is a perspective view of another version of the invention where a nut 24 is ready to be attached to the back of the cover support ledge. A mudcover bolt 3 will be inserted through the mudcover.

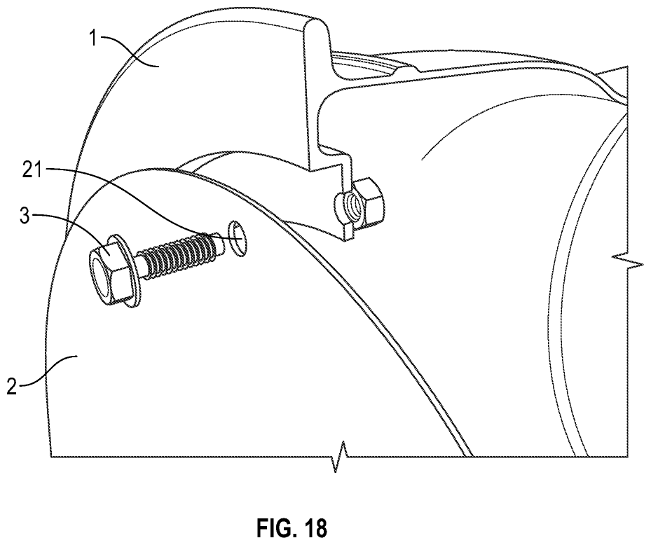

FIG. 18 is a perspective view of the embodiment of the invention described in FIG. 17 after the bolt has been attached. The nut 24 has been attached to the back of the cover support ledge, such that it won't spin as the mudcover bolt 3 is screwed in.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A mudcover/wheel device, consisting of: a wheel, a mudcover and at least one mudcover bolt, where the wheel comprises an aero lip, a tire bead area, a cover insert, a cover support ledge, at least one cover tab with a mudcover bolt hole, and a plug, where the plug is attached to the wheel and where the mudcover is attached directly to the wheel through the plug, where the mudcover comprises a flat, circular section and at least one mudcover bolt hole.

2. The device of claim 1, additionally comprising a threaded insert with a section of insert threads where the at least one mudcover bolt comprises a head, a pilot and a threaded section, where the threaded section of the at least one mudcover bolt mates with the section of insert threads, such that the mudcover can be removably secured to the cover support ledge of the wheel by inserting the pilot through the mudcover bolt hole and engaging the threaded section of the at least one mudcover bolt with the section of threads in the threaded insert.

3. The device of claim 2, where the threaded insert is on the cover tab, where the cover insert is a cylindrical section, with a cover insert circumference and a cover insert depth, where the cover insert circumference is larger than a mudcover circumference, where the cover insert depth is greater than a mudcover depth, where the plug has a plurality of plug threads.

4. The device of claim 3, where the cover insert depth is greater than the mudcover depth plus a head depth, where the head depth is the depth of the head of the mudcover bolt.

5. The device of claim 4, where the number of modules is four, where each module has a half-hole on both its right side and its left side, such that a single mudcover bolt removably secures two mudcover modules.

6. The device of claim 1, where the plug has a plurality of plug threads, where the at least one mudcover bolt comprises a head, a pilot and a threaded section, where the threaded section of the at least one mudcover bolt mates with a serrated plug, where the serrated plug has a plurality of serrated plug threads where the plurality of serrated plug threads are located on a serrated plug inside surface, where the serrated plug has a serrated plug outside surface that comprises a plurality of serrated ridges, such that when the serrated plug is inserted into a plug hole in the wheel, the serrated plug is secured in the plug hole and does not rotate, such that the mudcover can be removably secured to the cover support ledge of the wheel by inserting the pilot through the mudcover bolt hole and engaging the threaded section of the at least one mudcover bolt with the serrated plug threads, where the serrated plug is on the cover tab, where the cover insert is a cylindrical section, with a cover insert circumference and a cover insert depth, where the cover insert circumference is larger than a mudcover circumference, where the cover insert depth is greater than a mudcover depth.

7. The device of claim 1, where the plug has plug threads, where the at least one mudcover bolt comprises a head, a pilot and a threaded section, where the threaded section of the at least one mudcover bolt mates with a hexagonal plug, where the hexagonal plug is inserted into a hexagonal hole in the wheel, where the hexagonal plus has a plurality of hexagonal plug threads where the plurality of hexagonal plug threads are located on a hexagonal plug inside surface, such that when the hexagonal plug is inserted into the hexagonal hole in the wheel, the hexagonal plug is secured in the hexagonal hole and does not rotate, such that the mudcover can be removably secured to the cover support ledge of the wheel by inserting the pilot through the mudcover bolt hole and engaging the threaded section of the at least one mudcover bolt with the hexagonal plug threads, where the hexagonal plug is on the cover tab, where the cover insert is a cylindrical section, with a cover insert circumference and a cover insert depth, where the cover insert circumference is larger than a mudcover circumference, where the cover insert depth is greater than a mudcover depth.

8. The device of claim 1, where the plug consists of two rivets, a spring, and a screw with a slot, where the two rivets attach two ends of the spring to a cover insert, where the screw fits through a mudcover bolt hole, where the slot of the screw engages a straight portion of the spring, where as the screw is rotated, the slot causes the spring to tighten, thereby securing the mudcover to the cover insert.

9. A mudcover/wheel device, comprising: a wheel, a mudcover and at least one mudcover bolt, where the wheel comprises an aero lip, a tire bead area, a cover insert, a cover support ledge, at least one cover tab with a mudcover bolt hole, and a plug with plug threads, where the plug is attached to the wheel, where the mudcover comprises a flat, circular section and at least one mudcover bolt hole, where the mudcover attaches directly to the wheel and is removably secured by the at least one mudcover bolt being inserted through a mudcover bolt hole and engaging the plug threads.

10. The device of claim 9, where the at least one mudcover bolt comprises a head, a pilot and a threaded section, where the threaded section of the at least one mudcover bolt mates with a threaded insert with a section of insert threads, such that the mudcover can be removably secured to the cover support ledge of the wheel by inserting the pilot through the mudcover bolt hole and engaging the threaded section of the at least one mudcover bolt with the section of threads in the threaded insert, where the threaded insert is on the cover tab, where the cover insert is a cylindrical section, with a cover insert circumference and a cover insert depth, where the cover insert circumference is larger than a mudcover circumference, where the cover insert depth is greater than a mudcover depth.

11. The device of claim 10, where the cover insert depth is greater than the mudcover depth plus a head depth, where the head depth is the depth of the head of the mudcover bolt.

12. The device of claim 11, where the mudcover is modular as has more than one modules.

13. The device of claim 12, where the number of modules is four, where each module has a half-hole on both its right side and its left side, such that a single mudcover bolt removably secures two mudcover modules.

14. The device of claim 9, where the at least one mudcover bolt comprises a head, a pilot and a threaded section, where the threaded section of the at least one mudcover bolt mates with serrated plug, where the serrated plug has a plurality serrated plug threads where the plurality of serrated plug threads are located on a serrated plug inside surface, where the serrated plug has a serrated plug outside surface that comprises a plurality of serrated ridges, such that when the serrated plug is inserted into a plug hole in the wheel, the serrated plug is secured in the plug hole and does not rotate, such that the mudcover can be removably secured to the cover support ledge of the wheel by inserting the pilot through the mudcover bolt hole and engaging the threaded section of the at least one mudcover bolt with the serrated plug threads, where the serrated plug is on the cover tab, where the cover insert is a cylindrical section, with a cover insert circumference and a cover insert depth, where the cover insert circumference is larger than a mudcover circumference, where the cover insert depth is greater than a mudcover depth.

15. The device of claim 9, where the at least one mudcover bolt comprises a head, a pilot and a threaded section, where the threaded section of the at least one mudcover bolt mates with the section of insert threads, such that the mudcover can be removably secured to the cover support ledge of the wheel by inserting the pilot through the mudcover bolt hole and engaging the threaded section of the at least one mudcover bolt with the section of threads in the threaded insert, where the threaded insert is on the cover tab, where the cover insert is a cylindrical section, with a cover insert circumference and a cover insert depth, where the cover insert circumference is larger than a mudcover circumference, where the cover insert depth is greater than a mudcover depth.

16. A mudcover/wheel device, comprising: a wheel, a mudcover and at least one mudcover bolt, where the wheel comprises an aero lip, a cover insert, a cover support ledge, at least one cover tab, and a threaded insert with a section of insert threads, where the mudcover comprises a flat, circular section and at least one mudcover bolt hole, where the cover insert is a cylindrical section, with a cover insert circumference and a cover insert depth, where the cover insert circumference is larger than a mudcover circumference, such that the mudcover is removably inserted into a cavity in the areo wheel such that a mudcover edge of the mudcover is covered by a cover insert edge of the cover insert,

17. The device of claim 16, where the at least one mudcover bolt comprises a head, a pilot and a threaded section, where the threaded section of the at least one mudcover bolt mates with the section of insert threads, such that the mudcover can be removably secured to the cover support ledge of the wheel by inserting the pilot through a mudcover bolt hole and engaging the threaded section of the at least one mudcover bolt with the section of threads in the threaded insert, where the threaded insert is on the cover tab., where the cover insert is a cylindrical section, with a cover insert circumference and a cover insert depth, where the cover insert circumference is larger than a mudcover circumference.

18. The device of claim 16, where the cover attaches directly to the wheel, where the cover insert depth is greater than a mudcover depth, where the cover insert depth is greater than the mudcover depth plus a head depth, where the head depth is the depth of the head of the mudcover bolt, where the plug has plug threads, where the at least one mudcover bolt comprises a head, a pilot and a threaded section, where the threaded section of the at least one mudcover bolt mates with a serrated plug, where the serrated plug has a plurality of serrated plug threads where the plurality of serrated plug threads are located on a serrated plug inside surface, where the serrated plug has a serrated plug outside surface that comprises a plurality of serrated ridges, such that when the serrated plug is inserted into a plug hole in the wheel, the serrated plug is secured in the plug hole and does not rotate, such that the mudcover can be removably secured to the cover support ledge of the wheel by inserting the pilot through the mudcover bolt hole and engaging the threaded section of the at least one mudcover bolt with the serrated plug threads, where the serrated plug is on the cover tab, where the cover insert is a cylindrical section, with a cover insert circumference and a cover insert depth, where the cover insert circumference is larger than a mudcover circumference, where the cover insert depth is greater than a mudcover depth.

19. The device of claim 16, where the cover attaches directly to the wheel, where the cover insert depth is greater than a mudcover depth, where the cover insert depth is greater than the mudcover depth plus a head depth, where the head depth is the depth of the head of the mudcover bolt, where the plug has plug threads, where the at least one mudcover bolt comprises a head, a pilot and a threaded section, where the threaded section of the at least one mudcover bolt mates with a hexagonal plug, where the hexagonal plug is inserted into a hexagonal hole in the wheel, where the hexagonal plus has a plurality of hexagonal plug threads where the plurality of hexagonal plug threads are located on a hexagonal plug inside surface, such that when the hexagonal plug is inserted into the hexagonal hole in the wheel, the hexagonal plug is secured in the hexagonal hole and does not rotate, such that the mudcover can be removably secured to the cover support ledge of the wheel by inserting the pilot through the mudcover bolt hole and engaging the threaded section of the at least one mudcover bolt with the hexagonal plug threads, where the hexagonal plug is on the cover tab, where the cover insert is a cylindrical section, with a cover insert circumference and a cover insert depth, where the cover insert circumference is larger than a mudcover circumference, where the cover insert depth is greater than a mudcover depth.

20. The device of claim 16 where the cover attaches directly to the wheel, where the cover insert depth is greater than a mudcover depth, where the cover insert depth is greater than the mudcover depth plus a head depth, where the head depth is the depth of the head of the mudcover bolt, where the plug consists of two rivets, a spring, and a screw with a slot, where the two rivets attach two ends of the spring to a cover insert, where the screw fits through a mudcover bolt hole, where the slot of the screw engages a straight portion of the spring, where as the screw is rotated, the slot causes the spring to tighten, thereby securing the mudcover to the cover insert
